(19) United States
(12) Patent Application Publication
(10) Pub. No.: US 2010/0131361 A1
(43) Pub. Date: May 27, 2010

(54) METHOD, SYSTEM AND COMPUTER PROGRAM PRODUCT FOR DISTRIBUTING A MARKETING MESSAGE OVER MOBILE DEVICES

(76) Inventor: Lansing Arthur Parker II, Los Angeles, CA (US)

Correspondence Address: LANSING ARTHUR PARKER II, Apartment 239, 1632 N Laurel Ave, Los Angeles, CA, 90046, US

(21) Appl. No.: 12/362,863

(22) Filed: Jan. 30, 2009

Related U.S. Application Data
(60) Provisional application No. 61/117,946, filed on Nov. 25, 2008.

(51) Int. Cl. G06Q 30/00; H04W 4/12

(52) U.S. Cl. 705/14.49; 455/466

(57) ABSTRACT

A method for distributing a marketing message over mobile devices includes the steps of receiving an offer of an incentive for a user of a mobile device to participate in distributing the marketing message. The method includes the steps retrieving a contact list of individuals from the mobile device, the retrieving being facilitated by a software module received by the mobile device, and compiling a list of selected individuals from the contact list to receive the marketing message. The method includes the steps sending the selected individuals the marketing message, the sending being facilitated by the software module, and tracking a number of the selected individuals that were sent the marketing message.

### CROSS-REFERENCE TO RELATED APPLICATIONS

The present Utility patent application claims priority benefit of the U.S. provisional application for patent Ser. No. 61/117,946 filed Nov. 25, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to mobile applications. More particularly, the invention relates to an automatic text-a-friend feature on mobile devices.

### BACKGROUND OF THE INVENTION

Currently, there is a marketing need to automatically, with little or no effort by marketers, get a message out to consumers, especially to their mobile devices. Facebook has been successful at growing its social network with software that automatically emails the contacts in a user's email contact database. However, in many cases email is not the best method for reaching mobile devices. For example, without limitation, some mobile devices are not capable of receiving emails, and in some cases emails may take a long time to load on mobile devices.

Text messaging is often a better method than email for reaching the users of mobile devices, as motivated by statistics outlined at www.textsmsmarketing.com. For example, 80% of consumers have a mobile device with them all day. Consumers who are 18-29 years of age use text messaging more often than voice to communicate. On average, 94% of text messages are read, and, when given a choice, 39% of US consumers, or 76 million people, prefer text messages to radio or television advertising. However, only 3% of most marketing campaigns currently have a text component.

In view of the foregoing, there is a need for improved techniques for providing an effective marketing method for reaching mobile devices that requires little or no effort from marketers.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow chart illustrating an exemplary process for implementing a software attached version of text-a-friend marketing software, in accordance with an embodiment of the present invention;

FIG. 2 is a flow chart illustrating an exemplary process for implementing a standalone version of text-a-friend marketing software, in accordance with an embodiment of the present invention;

FIG. 3 illustrates an exemplary text message to a user informing the user of the text-a-friend process and incentive, in accordance with an embodiment of the present invention;

FIG. 4 illustrates an exemplary contact list compiled by text-a-friend marketing software, in accordance with an embodiment of the present invention; and

FIG. 5 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a method, system and computer program product for distributing a marketing message over mobile devices is presented.

In one embodiment, a method for distributing a marketing message over mobile devices is presented. The method includes the steps of receiving an offer of an incentive for a user of a mobile device to participate in distributing the marketing message. The method includes the steps retrieving a contact list of individuals from the mobile device, the retrieving being facilitated by a software module received by the mobile device and compiling a list of selected individuals from the contact list to receive the marketing message. The method includes the steps sending the selected individuals the marketing message, the sending being facilitated by the software module and tracking a number of the selected individuals that were sent the marketing message. Another embodiment further includes the step of deselecting individuals from the list that the user wishes to omit from receiving the marketing message. Yet another embodiment further includes the step of transmitting the number to a central server for determining if the user is eligible for an additional incentive. Still another embodiment further includes the step of transmitting the number to a central server for determining appropriate charges to a company associated with the marketing message. Another embodiment further includes the step of receiving the software module as an attachment to a software application, and the offer is included within the software module. Yet another embodiment further includes the step of receiving the software module as a result of accepting the offer. Still another embodiment further includes the step of receiving a notification that a one of the individuals carrying their mobile device is within a vicinity of the mobile device, the notification requesting whether the user wishes to send one of the individuals a message regarding the software application, and the step of if the user wishes, sending the message, where the message includes instructions for retrieving the software application. Another embodiment further includes the step if one of the individuals requests the software application, establishing a communication link between the mobile device and their mobile device. Yet another embodiment further includes the step of sending a message regarding the software application to at least one of the individuals when the at least one of the individuals enters a vicinity of the mobile device.

In another embodiment a method for distributing a marketing message over mobile devices is presented. The method includes steps for receiving an offer of an incentive, steps for retrieving a contact list on a mobile device, steps for compiling a list of selected individuals, steps for sending the selected individuals the marketing message; and steps for tracking a number of the selected individuals that were sent the marketing message. Another embodiment further includes steps for deselecting individuals from the list. Yet another embodiment further includes steps for transmitting the number to a central server. Still another embodiment further includes steps for sending a message to at least one of the individuals when the at least one of the individuals is within a vicinity of the mobile device. Another embodiment further includes steps for establishing a communication link between the mobile device and a mobile device of the at least one of the individuals.

In another embodiment a computer program product for distributing a marketing message over mobile devices is presented. The computer program product includes computer program code for receiving an offer of an incentive for a user of a mobile device to participate in distributing the marketing message. The computer program product includes computer program code for retrieving a contact list of individuals from the mobile device and computer program code for compiling a list of selected individuals from the contact list to receive the marketing message. The computer program product includes computer program code for sending the selected individuals the marketing message and including computer program code for tracking a number of the selected individuals that were sent the marketing message. A computer-readable medium stores the computer program code. Another embodiment further includes computer program code for deselecting individuals from the list that the user wishes to omit from receiving the marketing message. Yet another embodiment further includes computer program code for transmitting the number to a central server for determining if the user is eligible for an additional incentive. Still another embodiment further includes computer program code for transmitting the number to a central server for determining appropriate charges to a company associated with the marketing message. Another embodiment further includes computer program code for receiving the software module as an attachment to a software application, and the offer is included within the software module. Yet another embodiment further includes computer program code for receiving the software module as a result of accepting the offer. Still another embodiment further includes computer program code for receiving a notification that one of the individuals carrying their mobile device is within a vicinity of the mobile device, the notification requesting whether the user wishes to send one of the individuals a message regarding the software application, and computer program code for, if the user wishes, sending the message, where the message includes instructions for retrieving the software application. Another embodiment further includes computer program code for, if one of the individuals requests the software application, establishing a communication link between the mobile device and their mobile device. Yet another embodiment further includes computer program code for sending a message regarding the software application to at least one of the individuals when the at least one of the individuals enters a vicinity of the mobile device.

In another embodiment a system for distributing a marketing message over mobile devices is presented. The system includes means for offering an incentive for a user of a mobile device to participate in distributing the marketing message and means for retrieving a contact list on a mobile device, compiling a list of selected individuals, and sending the selected individuals the marketing message. Another embodiment further includes means for sending a message to at least one individual when at least one individual is within a vicinity of the mobile device. Yet another embodiment further includes means for establishing a communication link between the mobile device and a mobile device of at least one of individual.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide a method and means to virally grow the use of a mobile application or to get a marketing message out with little or no effort of the marketer or the developer of a mobile software application. Preferred embodiments may also be used to promote products, goods and services other than mobile software applications.

Preferred embodiments provide a mobile software application that assists in automatically perpetuating a marketing message for any company's product or the description of a mobile application so others can learn about its use and how to get it. Software in preferred embodiments accomplishes this by automatically retrieving the mobile phone number of every contact in a user's mobile device contact database and sending a predetermined text message to these contacts. The mobile device user is given a reward or incentive for participating in this process in preferred embodiments. Preferred embodiments also enable the text message/marketing message to be changed along with the incentive to the user for participating. In preferred embodiments, the software is able to work on all mobile devices as it is coded in all of the mobile operating systems. Preferred embodiments of the mobile software can be implemented in one of two ways: as a software attached version or as a standalone version.

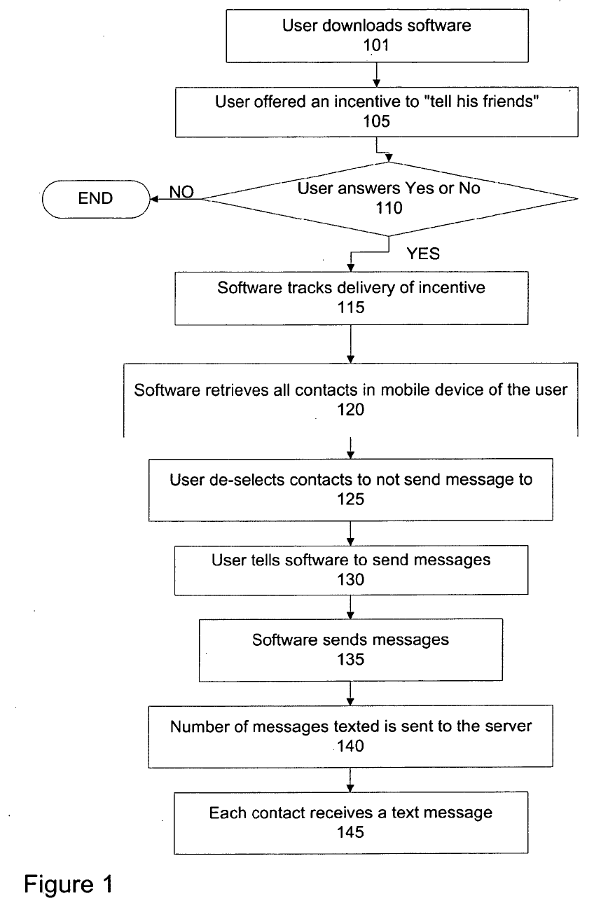

FIG. 1 is a flow chart illustrating an exemplary process for implementing a software attached version of text-a-friend marketing software, in accordance with an embodiment of the present invention. In the present embodiment, the process begins at step 101 where a user downloads application software onto his mobile device. The user may download the software using various different methods including, but not limited to, an over the air (OTA) software download, Bluetooth, infrared (IR), or connecting the mobile device to a computer, for example without limitation, through a universal serial bus (USB), and downloading the software over the Internet. As a part of the download the user is asked if he would like to “tell his friends” about the software he is downloading so that his “friends” can also have the opportunity to download and use or purchase the software in step 105. In alternate embodiments, the user may be asked to participate in the text-a-friend process in different ways. For example, without limitation, the user may be asked if he would like to “share this with his friends”, “pass it on”, “spread the word”, etc. In the present embodiment, the user is also offered a configurable reward or incentive for participating in step 105. The reward or incentive is configurable in that it can be changed to correspond with the type of application being promoted or to appeal to a specific target group of users. For example, without limitation, the chance to win a new cell phone for a cell phone based application. In alternate embodiments a reward or incentive may not be offered to the user. In the present embodiment step 105 may be performed before, after, or during the installation of the application software. In step 110 the user answers yes or no to the request to “tell his friends”. If the user chooses not to tell his friends the process ends, and if the user chooses to tell his friends, the process continues to step 115.

In step 115, the software tracks and manages the delivery of the reward or incentive for performing this function. The software may, for example, but not limited to, provide instructions on how to retrieve the reward of incentive, automatically download software or features that may constitute the reward or incentive or provide a link to where the reward or incentive can be retrieved. The software may also, but not limited to, provide codes or access keys that would allow the user to retrieve the reward or incentive. Then, in step 120, the software retrieves the mobile phone number of every contact in the user's contact database. The software automatically selects all of the contacts to receive a text message. Then, the user is given the opportunity to deselect all or uncheck specific contacts to which he does not want to send a text message in step 125. Once the user chooses which contacts to send the message to, he instructs the software to send the message in step 130, for example, without limitation, by clicking an OK button or a send button. The software automatically sends a predetermined text message to the user approved contacts in step 135. This predetermined text message may be configured by the provider of the mobile application to correspond with the application and the marketing message being promoted. Then in step 140, the software sends the number of friends automatically texted by the user to the server for tracking purposes. This can be used for various functions including, but not limited to, tracking the total number of messages being sent by the system, tracking additional incentives for the user that texts the most friends, monitoring how much to charge companies based on the number of messages sent for their software applications, etc. However, alternate embodiments may not track the number of messages sent. In the present embodiment, each contact receives a text message in step 145 that comprises the description of the mobile application software that the user downloaded. In this message the contacts are given the option to download the same software by clicking on a link, and the process repeats itself for that mobile device user and so on and so on. In some embodiments this process may be repeated for the original user at a regular interval for example, without limitation, every six weeks, once a year, etc.

A specific non-limiting example of an area where text-a-friend software may be implemented is in location based social networks such as, but not limited to, loopt.com and brightkite.com. In these applications users may use the text-a-friend feature to invite more members into the network as they download the software on to their mobile devices or at any other time they wish to automatically text their friends to join the social network since these location based service/mobile social networks must have software on the mobile devices in order to operate. The text-a-friend feature in this application is achieved using a process similar to the process described by way of example in accordance with FIG. 1. Those skilled in the art, in light of the present teachings, will readily recognize that text-a-friend software may be implemented along with various different types of software applications for example, without limitation, a location based video game on a mobile device where the player can text his friends so they can download and play also, social networking software that is not location based, location based social networking, media sharing software, location based systems or any mobile application that is downloaded to a mobile or handheld device, etc.

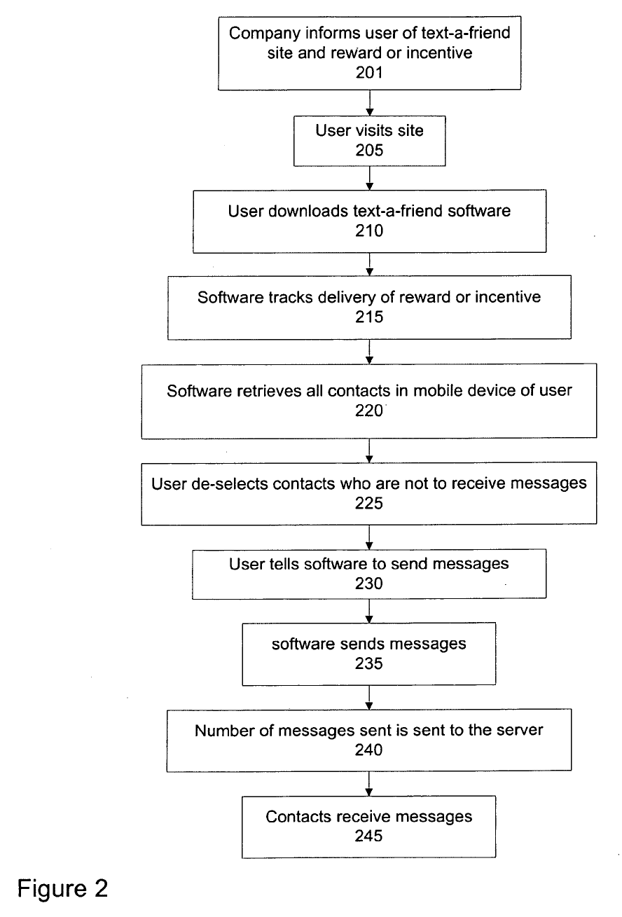

FIG. 2 is a flow chart illustrating an exemplary process for implementing a standalone version of text-a-friend marketing software, in accordance with an embodiment of the present invention. In the present embodiment, the standalone version comprises all of the features described in the software attached version illustrated by way of example in FIG. 1. However, the present embodiment can be used by any company or person in the world to market products, goods, services, etc., not only application software. The process begins at step 201 where the provider of a good, product or service informs users that they can earn a reward or incentive by visiting a website or address and downloading the software to tell their friends about the good, product or service being provided. The provider may use various means for informing the user of this such as, but not limited to, a text message, an email, an internet advertisement, a television or radio advertisement, a message on product packaging, etc. The incentive may be changed to correspond with the type of good, product or service being promoted or to appeal to a specific target group of users, and alternate embodiments may be implemented without an incentive. If a user is interested, the user visits the website or address on his mobile device in step 205. Once connected to the website or address, the user downloads the text-a-friend software onto his mobile device in step 210. In some embodiments, the user may not need to visit the website to get the software. There could be a link in the text message that directs their mobile device to the download page or the software could be installed from another mobile device via a communication link such as, but not limited to Bluetooth technology. The user may download the text-a-friend software using various methods including, but not limited to, an OTA software download, Bluetooth, IR, or connecting the mobile device to a computer and downloading the software over the Internet. In another non-limiting example, companies can use location based software as an incentive for users to text their friends. Companies can attach their marketing message to a text a friend feature already built in to the download process of the location based system.

In step 215, the software tracks and manages the delivery of the reward or incentive to the user. Then, in step 220, the software retrieves the mobile phone number of every contact in the user's contact database. Then, the user is given the opportunity to deselect all or uncheck contacts to which he does not want to send a text message in step 225. Once the user chooses which contacts to send the message to, he instructs the software to send the message in step 230, for example, without limitation, by clicking an OK button or a send button. The software automatically sends a predetermined text message to the user approved contacts in step 235. The text message may be configured by the provider of the good, product or service to correspond with the good, product or service and the marketing message being promoted. Then in step 240, the software sends the number of friends automatically texted by the user to the server for tracking purposes. This can be used for various functions including, but not limited to, to track the total number of messages being sent by the system, to track additional incentives for the user who texts the most friends, to monitor fees for a company based on how many messages are sent for their products or services, etc. Alternate embodiments may not track the number of messages sent. In the present embodiment, each contact receives a text message in step 245 that comprises the description of the good, product or service being promoted and how to get it. In some embodiments this process may be repeated at a regular interval for example, without limitation, every six weeks, once a year, etc.

In a non-limiting example of the use of a standalone version of text-a-friend marketing software in accordance with the present embodiment, a cell phone company tells customers to go to a website or an address on their mobile device to download text-a-friend marketing software that will refer their friends. The users are offered an incentive, for example, without limitation, a $10 gift card for a cell phone accessory, for helping the company market their specific goods or services. Those skilled in the art, in light of the present teachings, will readily recognize that virtually any good, product, or service may be marketed using text-a-friend marketing software according to the present embodiment.

Preferred embodiments may be a paid service for example, without limitation, a subscription, per text or otherwise based fee or preferred embodiments may be a way to co-market a mobile software application. The originating marketing entity would pay for these services. A non-limiting example of how this could be used to co-market a mobile application would be to provide an application for free to the user for texting friends about the product or service the entity was trying to market.

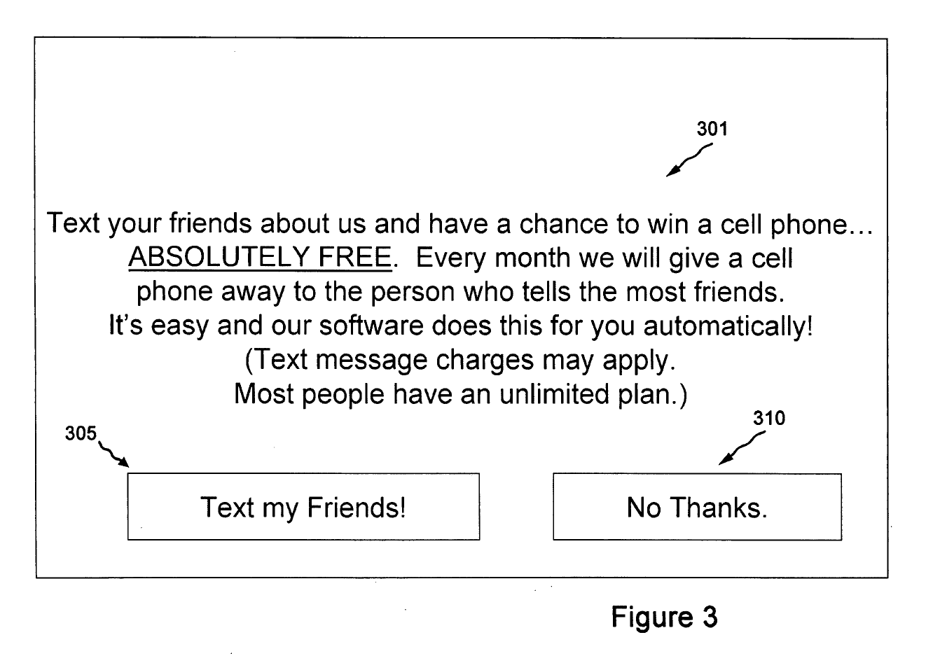

FIG. 3 illustrates an exemplary text message 301 to a user informing the user of the text-a-friend process and incentive, in accordance with an embodiment of the present invention. Text message 301 may be configured by the sender to convey information about the good, product or service being marketed and to relate to the targeted recipients. In the present embodiment, the user may accept the offer by clicking a “text my friends” button 305 or decline the offer by pressing a “no thanks” button 310. Message 301 and buttons 305 and 310 are shown here as examples and the message and buttons in alternate embodiments may be worded differently. Some alternate embodiments may comprise additional buttons to perform other tasks for example, without limitation, a “tell me more” button, a “don't text me again” button, etc.

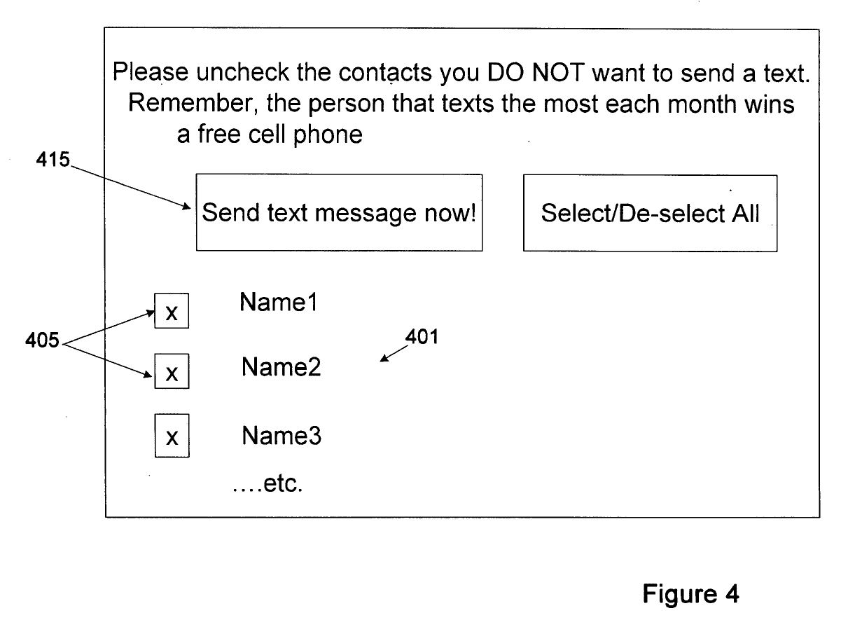

FIG. 4 illustrates an exemplary contact list 401 compiled by text-a-friend marketing software, in accordance with an embodiment of the present invention. In the present embodiment, contact list 401 comprises all of the contacts in the contact database of a user's mobile device. Each contact is automatically selected by the software by checking a box 405 next to the contact. After contact list 401 is compiled, the user can deselect all of the contacts by clicking a “select/deselect” button 410 or uncheck the friends they do not want to receive the marketing message by clicking boxes 405 next to these contacts. The user may also click “select/deselect” button 410 to restore the checks in every box 405. Once the user is satisfied with the contacts that are selected to receive the message, the user clicks a “send text message now” button 415 to send the message to the selected contacts.

In an alternate embodiment, the software automatically retrieves the cell phone number of each contact in a user's mobile device contact database and text messages each contact a marketing message without giving the user the option of deselecting contacts.

In another alternative embodiment, the software, in conjunction with a location based system, such as, but not limited to, a lost phone locator or friend locator software installed on the mobile device, could automatically alert people in a vicinity of the mobile device about the software through a message or text message between the mobile device and other nearby mobile devices. The message could be sent via a communication link such as, but not limited to Bluetooth technology. Those people can then decide if they would like to download the software by way of a link provided in the message that begins the download process. In other embodiments, the software could be downloaded from the mobile device using the communication link.

In another alternative embodiment, the software, in conjunction with a location based system, such as, but not limited to, a lost phone locator or friend locator software installed on the mobile device, could automatically alert the user when a person on the contact list in the mobile device is within a vicinity of the mobile device. The software would ask the user if a message about the software should be sent to the person. If the person would like to download the software, the person would use a link provided in the message. Alternatively, the person could download the software using a communication link such as, but not limited to Bluetooth technology where the person downloads the software from the user's mobile device.

In other alternate embodiments, text-a-friend software may be implemented for purposes other than marketing such as, but not limited to, broadcasting public service announcements, weather alerts, election campaign messages, etc. For example, without limitation, a user may be signed up to receive severe weather alerts on his mobile device. When the user receives the alert, he is then able to employ the text-a-friend software to forward this alert to any or all of his contacts.

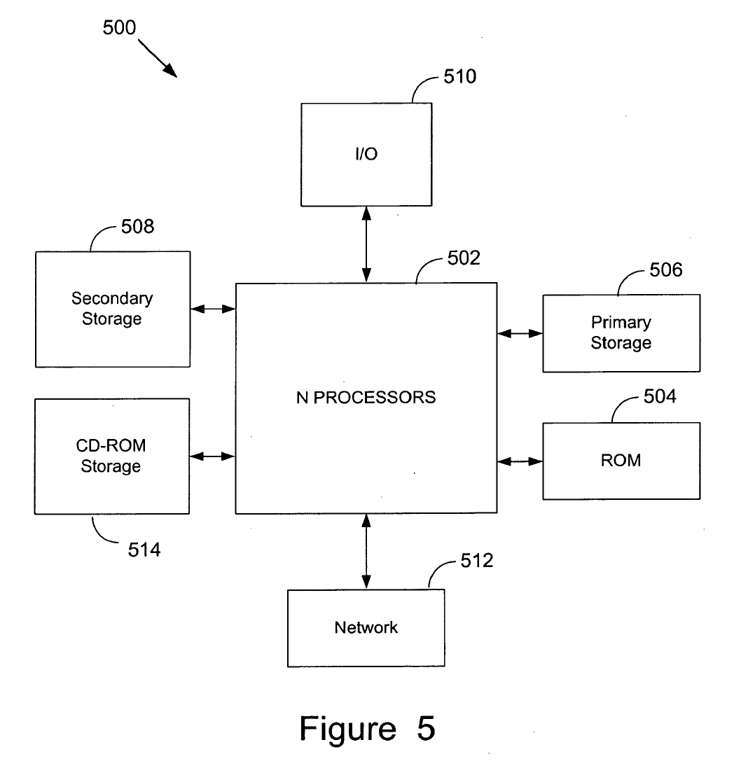

FIG. 5 illustrates a typical computer system that, when appropriately configured or designed, can serve as a computer system in which the invention may be embodied. The computer system 500 includes any number of processors 502 (also referred to as central processing units, or CPUs) that are coupled to storage devices including primary storage 506 (typically a random access memory, or RAM), primary storage 504 (typically a read only memory, or ROM). CPU 502 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 504 acts to transfer data and instructions uni-directionally to the CPU and primary storage 506 is used typically to transfer data and instructions in a bi-directional manner. Both of these primary storage devices may include any suitable computer-readable media such as those described above. A mass storage device 508 may also be coupled bi-directionally to CPU 502 and provides additional data storage capacity and may include any of the computer-readable media described above. Mass storage device 508 may be used to store programs, data and the like and is typically a secondary storage medium such as a hard disk. It will be appreciated that the information retained within the mass storage device 508, may, in appropriate cases, be incorporated in standard fashion as part of primary storage 506 as virtual memory. A specific mass storage device such as a CD-ROM 514 may also pass data uni-directionally to the CPU.

CPU 502 may also be coupled to an interface 510 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to an external device such as a database or a computer or telecommunications or internet network using an external connection as shown generally at 512, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, information processing performed by the servers may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing an automatic text-a-friend marketing method according to the present invention will be apparent to those skilled in the art. The invention has been described above by way of illustration, and the specific embodiments disclosed are not intended to limit the invention to the particular forms disclosed. For example, the particular implementation of the software may vary depending upon the particular type of intended user. The users described in the foregoing were directed to individuals; however, similar techniques are to apply a text-a-friend marketing method to a company or other type of community where the software is able to access a central database of employees or members from which to compile a list of contacts. Implementations of the present invention that target groups as well as individual users are contemplated as within the scope of the present invention. The invention is thus to cover all modifications, equivalents, and alternatives falling within the spirit and scope of the following claims.

What is claimed is:

1. A method for distributing a marketing message over mobile devices, the method comprising the steps of:
receiving an offer of an incentive for a user of a mobile device to participate in distributing the marketing message;
retrieving a contact list of individuals from said mobile device, said retrieving being facilitated by a software module received by said mobile device;
compiling a list of selected individuals from said contact list to receive the marketing message;
sending said selected individuals the marketing message, said sending being facilitated by said software module; and
tracking a number of said selected individuals that were sent the marketing message.

2. The method as recited in claim 1, further comprising the step of deselecting individuals from said list that said user wishes to omit from receiving the marketing message.

3. The method as recited in claim 1, further comprising the step of transmitting said number to a central server for determining if said user is eligible for an additional incentive.

4. The method as recited in claim 1, further comprising the step of transmitting said number to a central server for determining appropriate charges to a company associated with the marketing message.

5. The method as recited in claim 1, further comprising the step of receiving said software module as an attachment to a software application, and said offer is included within said software module.

6. The method as recited in claim 1, further comprising the step of receiving said software module as a result of accepting said offer.

7. The method as recited in claim 5, further comprising the step of receiving a notification that a one of said individuals carrying their mobile device is within a vicinity of said mobile device, said notification requesting whether said user wishes to send said one of said individuals a message regarding said software application, and the step of if said user wishes, sending said message, where said message includes instructions for retrieving said software application.

8. The method as recited in claim 7, further comprising the step of if said one of said individuals requests said software application, establishing a communication link between said mobile device and their mobile device.

9. The method as recited in claim 5, further comprising the step of sending a message regarding said software application to at least one of said individuals when said at least one of said individuals enters a vicinity of said mobile device.

10. A method for distributing a marketing message over mobile devices, the method comprising:
steps for receiving an offer of an incentive;
steps for retrieving a contact list on a mobile device;
steps for compiling a list of selected individuals;
steps for sending said selected individuals the marketing message; and
steps for tracking a number of said selected individuals that were sent the marketing message.

11. The method as recited in claim 10, further comprising steps for deselecting individuals from said list.

12. The method as recited in claim 10, further comprising steps for transmitting said number to a central server.

13. The method as recited in claim 10, further comprising steps for sending a message to at least one of said individuals when said at least one of said individuals is within a vicinity of said mobile device.

14. The method as recited in claim 13, further comprising steps for establishing a communication link between said mobile device and a mobile device of said at least one of said individuals.

15. A computer program product for distributing a marketing message over mobile devices, the computer program product comprising:
computer program code for receiving an offer of an incentive for a user of a mobile device to participate in distributing the marketing message;
computer program code for retrieving a contact list of individuals from said mobile device;
computer program code for compiling a list of selected individuals from said contact list to receive the marketing message;
computer program code for sending said selected individuals the marketing message;
comprising computer program code for tracking a number of said selected individuals that were sent the marketing message; and
a computer-readable medium storing said computer program code.

16. The computer program product as recited in claim 15, further comprising computer program code for deselecting individuals from said list that said user wishes to omit from receiving the marketing message.

17. The computer program product as recited in claim 15, further comprising computer program code for transmitting said number to a central server for determining if said user is eligible for an additional incentive.

18. The computer program product as recited in claim 15, further comprising computer program code for transmitting said number to a central server for determining appropriate charges to a company associated with the marketing message.

19. The computer program product as recited in claim 15, further comprising computer program code for receiving said software module as an attachment to a software application, and said offer is included within said software module.

20. The computer program product as recited in claim 15, further comprising computer program code for receiving said software module as a result of accepting said offer.

21. The computer program product as recited in claim 19, further comprising computer program code for receiving a notification that a one of said individuals carrying their mobile device is within a vicinity of said mobile device, said notification requesting whether said user wishes to send said one of said individuals a message regarding said software application, and computer program code for, if said user wishes, sending said message, where said message includes instructions for retrieving said software application.

22. The computer program product as recited in claim 21, further comprising computer program code for, if said one of said individuals requests said software application, establishing a communication link between said mobile device and their mobile device.

23. The computer program product as recited in claim 19, further comprising computer program code for sending a message regarding said software application to at least one of said individuals when said at least one of said individuals enters a vicinity of said mobile device.

24. A system for distributing a marketing message over mobile devices, the system comprising:
means for offering an incentive for a user of a mobile device to participate in distributing the marketing message; and
means for retrieving a contact list on a mobile device, compiling a list of selected individuals, and sending said selected individuals the marketing message.

25. The system as recited in claim 24, further comprising means for sending a message to at least one individual when said at least one individual is within a vicinity of said mobile device.

26. The system as recited in claim 25, further comprising means for establishing a communication link between said mobile device and a mobile device of at least one of individual.
